(19) United States
(12) Patent Application Publication
(10) Pub. No.: US 2010/0321950 A1
(43) Pub. Date: Dec. 23, 2010

(54) WATER-COOLING MODULE FOR LED HEADLAMP

(76) Inventor: Shwin-Chung WONG, Hsinchu (TW)

Correspondence Address: Muncy, Geissler, Olds & Lowe, PLLC, 4000 Legato Road, Suite 310, FAIRFAX, VA, 22033, US

(21) Appl. No.: 12/553,419

(22) Filed: Sep. 3, 2009

(30) Foreign Application Priority Data
Jun. 23, 2009 (TW) 98120997

(51) Int. Cl. B60Q 1/00

(52) U.S. Cl. 362/547

(57) ABSTRACT

A replaceable water-cooling module for LED headlamp includes a water-cooling head located outside an open hole of a housing and an LED light module with its substrate mounted over the open hole against the inner wall of the housing, using a set of detachable mounting elements through a plurality of mounting holes around the open hole. The water-cooling head is mounted against the substrate of the LED light module, using another set of detachable mounting elements. The bottom surface of the LED substrate directly contacts with the base surface of the water-cooling head through the open hole. The heat generated by the LED lights, through the LED substrate, effectively transmits to the water cooling head.

### BACKGROUND OF THE INVENTION

1. Field of the Invention

The present invention relates to a heat dissipation module, and more particularly to a water-cooling module for an LED headlamp.

2. Background of the Related Art

LED has been gradually applied to the luminous device of the automobile headlamp because of power saving, small volume and high luminous efficiency. The luminous efficiency or the life of the LED chip is highly correlative to its junction temperature. When the LED chips are installed in the headlamps, which are near the hot and space-limited region of the automobile engine, the cooling of the LED chips is highly challenging. In such an environment, a water cooling system has the advantages of high heat dissipation ability, small configuring space and good compatibility to the pre-existing fan in the automobile, as disclosed by the water-cooling module of a headlamp in Taiwan Patent M334060. As shown in FIG. 1, the headlamp 10 includes a base 12 having a heat conduction portion 14, an inner heat dissipation component 16, and an outer water cooling component 18 separated from the inner heat dissipation component 16. The heat generated by the LED element 20 is transferred from the inner wall of the base 12 through the inner heat dissipation component 16, the heat conduction portion 14 and the outer water cooling component 18 to a condenser 24 in front of the automobile fan, and finally dissipated in the air.

However, when the base 12 transfers its heat through the heat conduction portion 14, the multiple contact interfaces at both sides of the heat conduction portion 14 present high contact thermal resistances to lower the heat dissipation efficiency. Moreover, it is difficult to combine the base 12 and the heat conduction portion 14 because the base 12 is generally made of plastic and the heat conduction portion 14 is generally made of a metal.

### SUMMARY OF THE INVENTION

An aspect of this invention is to provide a water-cooling module for an LED headlamp. The bottom surface of the LED substrate directly contacts with the water cooling head or additionally through a highly conductive heat pipe to decrease the thermal resistance, so that the heat generated by the LED lights can be effectively transmitted.

Another aspect of this invention is to provide a replaceable water-cooling module for LED headlamp. The mounting base and the water cooling head are assembled by using a plurality of detachable mounting elements, so that the mounting base or the water cooling head can be easily replaced.

Accordingly, one example of the present invention provides a water-cooling module for LED headlamp including: a water-cooling head; a mounting base having a first surface and an opposite second surface, with the mounting base mounted on the inner wall of a housing having an open hole and a plurality of mounting holes around the open hole; a plurality of first detachable mounting elements through the mounting base and the mounting holes, making the mounting base over the open hole against the inner wall of the housing, with a portion of the first surface exposed outward via the open hole; a plurality of second detachable mounting elements used to press the bottom surface of the water-cooling head against the exposing first surface of the mounting base; and an LED light module mounted within the housing.

### BRIEF DESCRIPTION OF THE DRAWINGS

FIG. 1 is a diagram illustrating a traditional LED headlamp of an automobile;

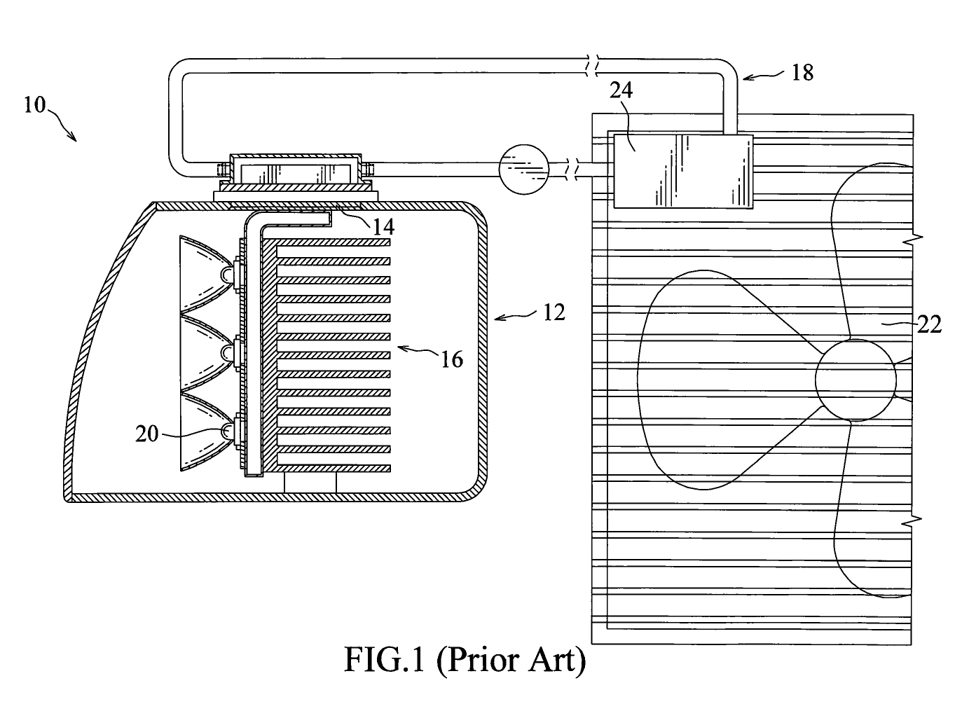

FIG. 2 is a diagram illustrating a water-cooling module for an LED headlamp in accordance with an example of the present invention; and

FIG. 3 is a diagram illustrating a water-cooling module for an LED headlamp in accordance with another example of the present invention.

### DETAILED DESCRIPTION OF THE INVENTION

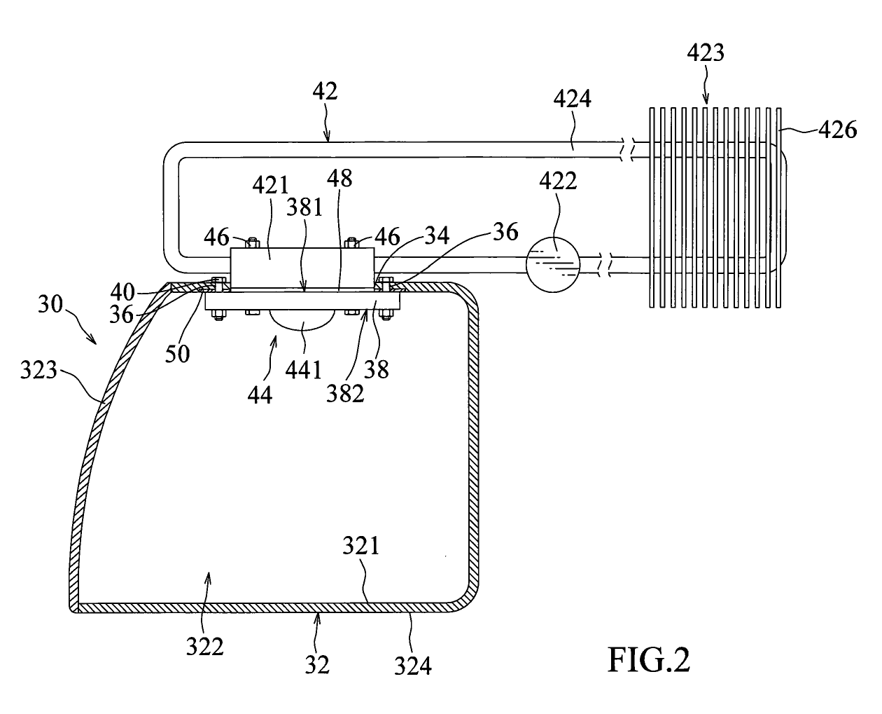

FIG. 2 is a diagram illustrating a water-cooling module for an LED headlamp in accordance with an aspect of the present invention. The LED headlamp 30 has a housing 32 surrounding an enclosure 322, an open hole 34 formed on the housing, and a plurality of mounting holes 36 formed on the housing 32 around the open hole 34. The water-cooling module 42 includes a water-cooling head 421, a mounting base 38, a plurality of first detachable mounting elements 40, a plurality of second detachable mounting elements 46 and an LED light module 44. The mounting base 38 has a first surface 381 and a second surface 382, opposite to each other. The first detachable mounting elements 40 passes through the outer edge of the mounting base 38 and the mounting holes 36 to fix and attach the mounting base 38 on the inner wall 321 of the housing 32 and over the open hole 34. The central portion of the first surface 381 is exposed outward via the open hole 34 with its periphery adhering to the inner wall 321 of the housing 32. The second detachable mounting elements 46 are configured on the peripheral portion to mount the mounting base 38 on the water-cooling head 421, wherein the first surface 381 of the mounting base 38 contacts with the bottom surface of the water-cooling head 421. The LED light module 44 is mounted on the second surface 382 of the mounting base 38 within the enclosure 322. In one example, the mounting base 38 is an LED substrate and the LED light module 44 includes a plurality of LED elements 441 connected with the LED substrate.

The housing 32 includes a base 324 and a front cover lens 323 covering the base 324. The open holes 34 and the mounting holes 36 are formed on the base 324. In one example, the mounting holes 36 are screw holes and the first detachable mounting elements 40 are a plurality of screw sets, which pass through the outer edge of the mounting base 38 and the screw holes to fix the mounting base 38 within the enclosure 322 onto the housing 32 and over the open hole 34. The second detachable mounting elements 46 are also a plurality of screw sets to screw the mounting base 38 onto the water-cooling head 421, as shown in FIG. 2. In another example, at least one flat fixing plate with screw holes (not shown) spans across the top of the water-cooling head 421 and the second detachable mounting elements 46 pass through the screw holes of the fixing plate, so that the mounting base 38 is combined with the water-cooling head 421 without passing through the water-cooling head 421.

Furthermore, the periphery of the exposed portion of the first surface 381 can be configured with a seal layer 50 or seal material to enhance the closeness between the mounting base 38 and the base 324 and prevent the external materials, such as water or dust, from entering the housing 32 via the open hole 34. In one example, the LED elements are arranged to face the front cover lens 323 and radiate light to the front cover lens 323 directly. In another example, the LED elements are not arranged to face the front cover lens, but an additional reflector (not shown) is configured in the housing 32 to form a light path for guiding the light radiated by the LED elements through the front cover lens.

The water-cooling module 42 further includes a water circulating pump 422, a condenser 423 and a pipe 424 connecting the water-cooling head 421, the water circulating pump 422, and the condenser 423 to form a water-cooling circulating loop. In one example, the condenser 423 is implemented as a set of fin 426 connected with the pipe 424 in a vertical alignment so that the heat from the LED lights can be adequately dissipated in a natural convection mode even when the automobile fan is not running.

In the LED headlamp 30, the heat generated by the LED elements 441 can be effectively transmitted to the water cooling head 421 through the mounting base 38 due to the direct contact between the mounting base 38 surface and the bottom surface of the water-cooling head 421. The working fluid inside the water cooling head 421 absorbs the heat and flows along the circulating loop, driven by the water circulating pump 422, to the condenser 423, where the heat is dissipated. Furthermore, a thermal interface material 48 is applied at the interfaces between the first surface 381 of the mounting base 38 and the bottom surface of the water-cooling head 421 to increase the heat conduction efficiency. Besides, if the LED headlamp has a plurality of LED light modules configured in either the same housing or different adjacent housings, the water-cooling module 42 can comprise a plurality of water-cooling heads to match these LED light modules. The water-cooling heads can be integrated in series into the water-cooling circulating loop.

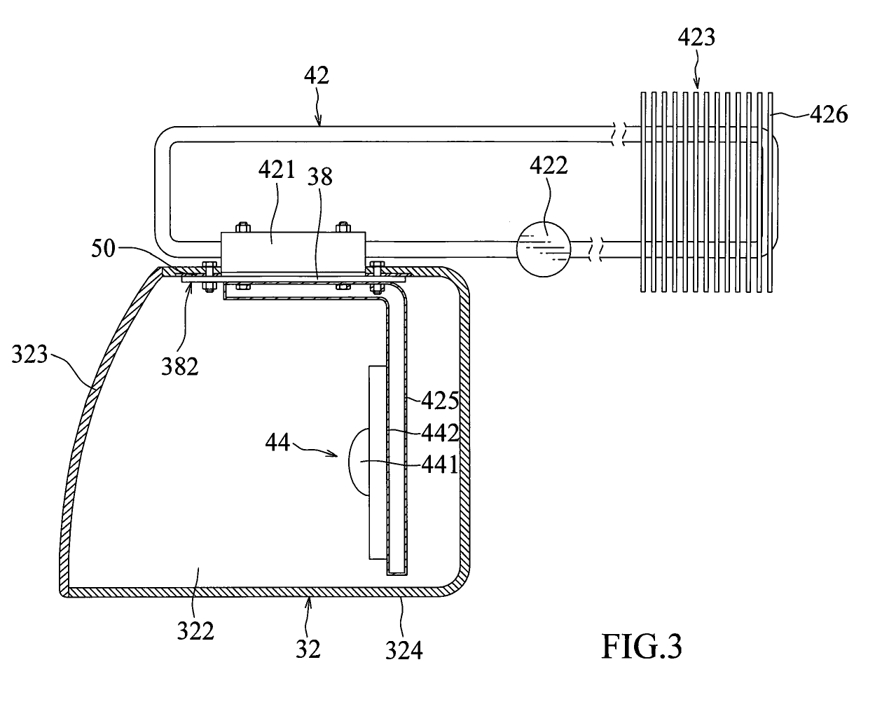

In another example, the water-cooling module 42 further includes a heat pipe 425 within the enclosure 322. As shown in FIG. 3, a terminal of the heat pipe 425 connects to the second surface 382 of the mounting base 38 and the other terminal connects to the LED substrate 442. In this example, the heat generated by the lights of the LED elements 441 is transmitted to the water cooling head 421 via the LED substrate 442, the heat pipe 425 and the mounting base 38. Then, the heat is carried along the water-cooling circulating loop to the condenser 423 and dissipated to the ambient air.

In the present invention, a plurality of detachable mounting elements are used in the assembly of the mounting base and the water cooling head so that the replacement procedure can be simplified. Furthermore, because of the design of the open hole, the mounting base directly or via the thermal interface material contacts with the water cooling head so that the thermal resistance between the mounting base and the water cooling head is decreased to have high efficiency of heat dissipation. Beside, because of adequate closeness between the mounting base and the base of the LED headlamp, water or dust can be prevented from entering the housing of the LED headlamp.

Although the present invention has been explained in relation to its preferred example, it is to be understood that other modifications and variation can be made without departing the spirit and scope of the invention as hereafter claimed.

What is claimed is:

1. A water-cooling module for LED headlamp, comprising:
a water-cooling head;
a mounting base having a first surface and a second surface opposite to said first surface, said mounting base being mounted on the inner wall of a housing having an open hole and a plurality of mounting holes arranged around said open hole, and said housing forming an enclosure;
a plurality of first detachable mounting elements through said mounting base and said mounting holes, to make said mounting base over said open hole and against said inner wall of said housing, and a portion of said first surface exposing outward via said open hole;
a plurality of second detachable mounting elements for mounting said water-cooling head against said exposing first surface of said mounting base; and
an LED light module mounted within said enclosure.

2. The water-cooling module for LED headlamp according to claim 1, wherein said mounting base is an LED substrate, and said LED light module comprises a plurality of LED elements connecting with said second surface of said mounting base.

3. The water-cooling module for LED headlamp according to claim 1, wherein said LED light module comprises a substrate connecting with said second surface of said mounting base, and a plurality of LED elements electrically connect with the substrate.

4. The water-cooling module for LED headlamp according to claim 1, further comprising a heat pipe configured within said enclosure, wherein a terminal of said heat pipe connects with said second surface of said mounting base, and another terminal of said heat pipe connects with said LED light module.

5. The water-cooling module for LED headlamp according to claim 1, further comprising a thermal interface material arranged between said water-cooling head and said exposing first surface.

6. The water-cooling module for LED headlamp according to claim 1, wherein said first detachable mounting elements include a plurality of screw sets.

7. The water-cooling module for LED headlamp according to claim 1, wherein said second detachable mounting elements include a plurality of screw sets.

8. The water-cooling module for LED headlamp according to claim 1, further comprising a seal material arranged on an interface of said first surface against said inner wall of said housing.

9. The water-cooling module for LED headlamp according to claim 1, further comprising a water circulating pump, a condenser and a pipe connecting said water-cooling head, said water circulating pump and said condenser to form a water-cooling circulating loop.

10. The water-cooling module for LED headlamp according to claim 1, wherein said condenser comprises a set of fins connected with said pipe.

11. The water-cooling module for LED headlamp according to claim 1, wherein said housing comprises a base and a front cover lens covering said base.
